(19) United States
(12) Patent Application Publication
(10) Pub. No.: US 2006/0272890 A1
(43) Pub. Date: Dec. 7, 2006

(54) Lanyard electronic message device

(76) Inventors: James Harmon, Euclid, OH (US); Sonia Maynor, Euclid, OH (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/405,675

(22) Filed: Apr. 18, 2006

Related U.S. Application Data
(60) Provisional application No. 60/594,549, filed on Apr. 18, 2005.

(51) Int. Cl. A62B 35/00

(52) U.S. Cl. 182/3

(57) ABSTRACT

A lanyard for electronic message devices, such as cell phones, includes in one embodiment a carabiner clip for attaching the cell phones to an item of clothing such as a belt loop or to a handle of a purse. In another embodiment, the lanyard is configured as a relatively long loop so as to be worn around the person's neck. The cell phone is attached to the lanyard by a quick release key ring coupler. In accordance with a first arrangement, the cell phone is connected to the lanyard by a split ring and in accordance with a second embodiment, the cell phone is connected by a looped strand.

### RELATED APPLICATIONS

This application claims priority from provisional application Ser. No. 60/594,549 filed Apr. 18, 2005.

### FIELD OF THE INVENTION

The present invention relates to a lanyard for electronic message devices. More particularly, the present invention is related to a lanyard for electronic messaging devices, such as but not limited to, cell phones, Blackberry or music storage devices.

### BACKGROUND OF THE INVENTION

Electronic communication devices, such as cell phones, are now ubiquitous throughout the world's population. These devices are in almost all cases carried in the person's pocket or in a bag such as a pocket book or in a compartment, such as but not limited to, a compartment in an automotive vehicle. Since these devices are wireless and thus portable, they may be used at almost any location on earth. Since electronic communication devices are readily separable from one's person, they are frequently lost or stolen, leading to substantial inconvenience and/or worry by their owners. Cell phones now contain enormous amounts of personal information, as well as access to data banks of additional information. Loss of theft of a cell phone can be a very serious matter.

Frequently, it is necessary or desirable to hand a cell phone to another person or to detach the cell phone from one's person or purse while performing an activity, such as but certainly not limited to, swimming. To date, there has been no convenient way to accomplish these ends.

### SUMMARY OF THE INVENTION

In view of the above-mentioned considerations, the present invention is directed to a lanyard for carrying an electronic communication device, such as but not limited to, a cell phone. The lanyard comprises a strap of flexible material having first and second end portions wherein the first end portion attaches the strap of flexible material to a person, and the second end portion has a coupler for attachment to the electronic communications device. The coupler comprises a first loop having a substantially rigid configuration, the loop being received in a complementary loop formed in the strap of flexible material. A quick release key ring having a first part with a first aperture therethrough receives the first loop, allowing the first end part in the strap of material to slide on the first loop. A second part of the quick release key ring has a second aperture therethrough for receiving a second loop. The second loop of the key release key ring is connected to the electronic communications device.

In one embodiment of the invention the strap is formed as a loop with a first end portion of the strap looping around the neck of the person and the second end portion being substantially displaced from the first end portion, whereby the electronics communications device is either suspended from the person's neck or can be received in the person's shirt or jacket pocket while retained on a person's neck.

In a further aspect of the invention, the aforementioned strap comprising lanyard is non-elastic.

In another embodiment of the invention, the strap is elastic so as to be elongatable.

In still another aspect of the invention, a carabiner is attached to the first end of the elastic strap so that the lanyard may be attached to an article of clothing or to a handbag or purse.

In still a further aspect of the invention, the first and second loops are split rings.

In still a further aspect of the invention the second loop is at least one flexible strand which is coupled to the quick release key ring at one portion thereof and attached to the electronic communications device at the other end portion thereof.

### BRIEF DESCRIPTION OF THE DRAWINGS

Various other features and attendant advantages of the present invention will be more fully appreciated as the same becomes better understood when considered in conjunction with the accompanying drawings, in which like reference characters designate the same or similar parts throughout the several views, and wherein:

FIG. 1 is a perspective view showing a lanyard attaching a cell phone to a loop on a person's clothing with the cell phone stored in the person's pocket;

FIG. 2 is a perspective view showing the cell phone of FIG. 1 suspended from the loop;

FIG. 3 is a side view showing a cell phone connected by a looped strand to the lanyard;

FIG. 4 is a view similar to FIG. 3 but showing the cell phone connected to the lanyard of FIGS. 1 and 2 by a split ring;

FIGS. 5A-5C are side views showing various arrangements for a quick release key chain used to attach the cell phone to the lanyard;

FIG. 6 is an exploded view of the quick release key ring arrangement of FIGS. 5A-5C, and

FIG. 7 is a side view of a second embodiment of the invention wherein the lanyard can be the one around a person's neck.

### DETAILED DESCRIPTION OF THE DRAWINGS

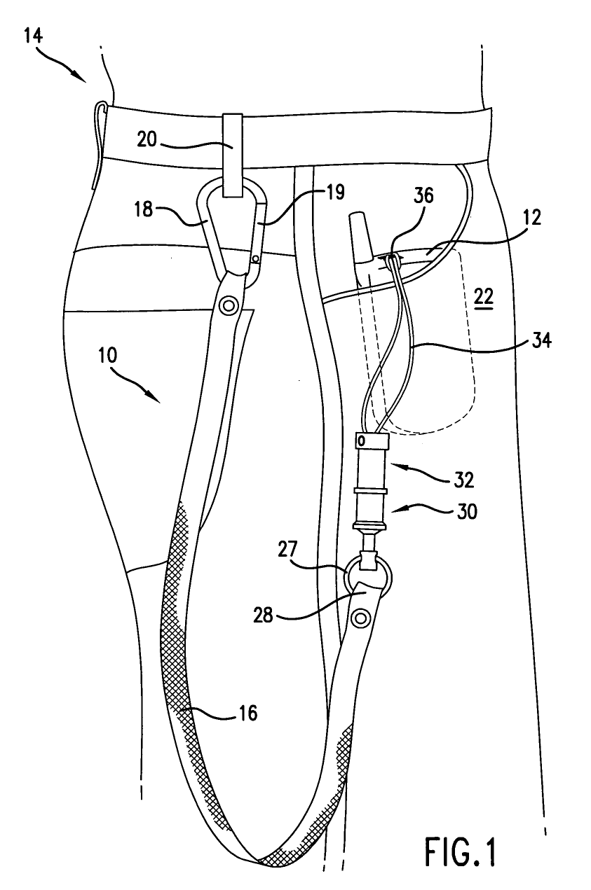

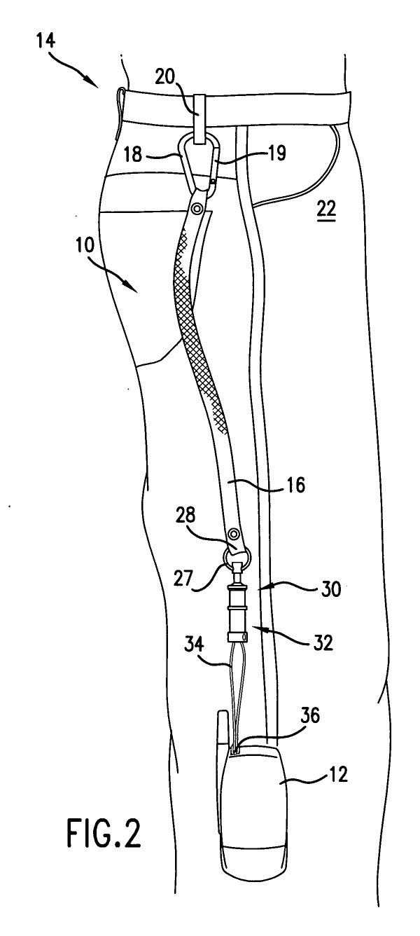

FIGS. 1 and 2 illustrate a first embodiment of a lanyard 10 for attaching a portable electronic communication device 12, e.g., a cell phone, to the clothing 14 of a person. In FIG. 1, the lanyard 10 comprises a strap 16 of flexible material that has a carabiner 18 in the form of a “C-clip” with a closure link 19 that clips around a belt loop 20. The electronic communications device 12 which in the illustrations is a cell phone, is carried in a clothing pocket 22. Preferably, the strap 16 is elastic so that its length is not excessive and it can be carried at a location such as the pocket 22 adjacent the point of attachment by the carabiner 18, such as the belt loop 20, so as not to dangle excessively. The lanyard 10 shown in FIGS. 1 and 2 is relatively long with the strap being about 1 foot long and being extendible comfortably to about 18 inches and with more stress to about 2 feet.

In another aspect of the invention, the strap 16 of the lanyard is about 6 to 7 inches long, and preferably about 6½ inches long. In this embodiment, the carabiner 18 is attached to the strap of a pocketbook or purse (not shown) and the electronic communication device 12 rests inside when not being used. As will be explained hereinafter, the cell phone 12 is attached to the lanyard 10 by a coupler 30 having a quick release key ring 32 so that the cell phone can be readily removed from the lanyard 10 for use. After the person is finished using the cell phone 12 the quick release key ring is reattached to the cell phone and cell phone is dropped into the purse. In this way, the cell phone can be readily found in a crowded purse by simply pulling on the lanyard 10. The lanyard 10 of FIG. 2 may be used with bags other than a purse or any other portable or non-portable container.

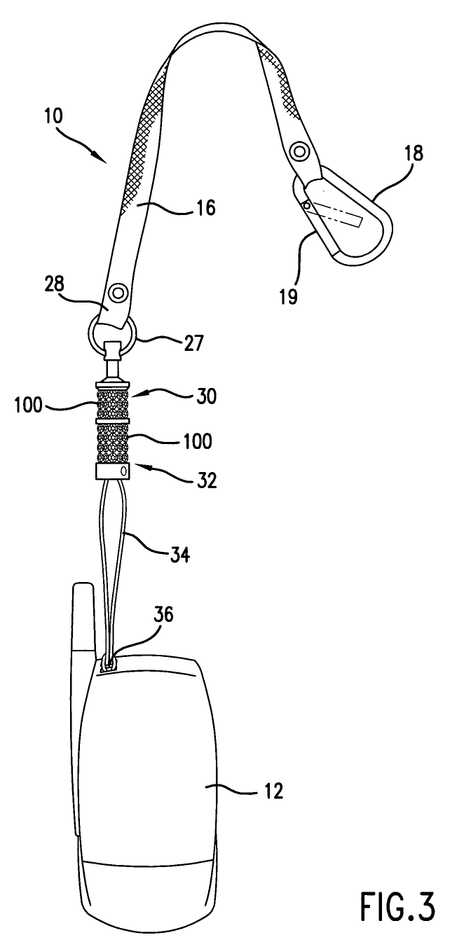

Referring now to FIG. 3 there is shown one embodiment of the invention wherein the cell phone 12 is connected to the quick release key ring 32 by a looped strand 34 which fits around a bar 36 on the cell phone 12. As will be described further hereinafter, the strand 34 is configured as a loop which is retained in the releasable key ring 32. A preferable structure for the loop 34 is a single strand of fishing line of relatively high test, for example 20 to 100 pounds, but other strand arrangements may be utilizes such as, but not limited to, cords of multiple strands, wires, or ribbons.

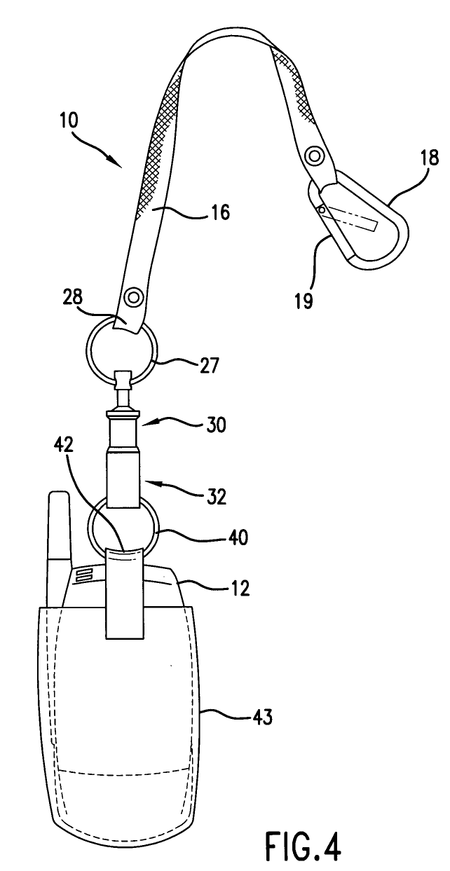

Referring now to FIG. 4, where another arrangement is utilized to attach the cell phone 12 to the releasable key ring 32, a second split ring 40 is passed through a pair of straps 42 at the top of the cell phone. The second split ring 40 is in the form of a short coil of thin steel rod having two free ends adjacent a bend in the rod when the rod is coiled. The straps 42 are slid past the free ends of the rod and migrate to the center 34 of the rod so as to in effect be looped by coiled rod forming the split ring 40. Thus, the second split ring 40 connects to the case 43 of the cell phone 12.

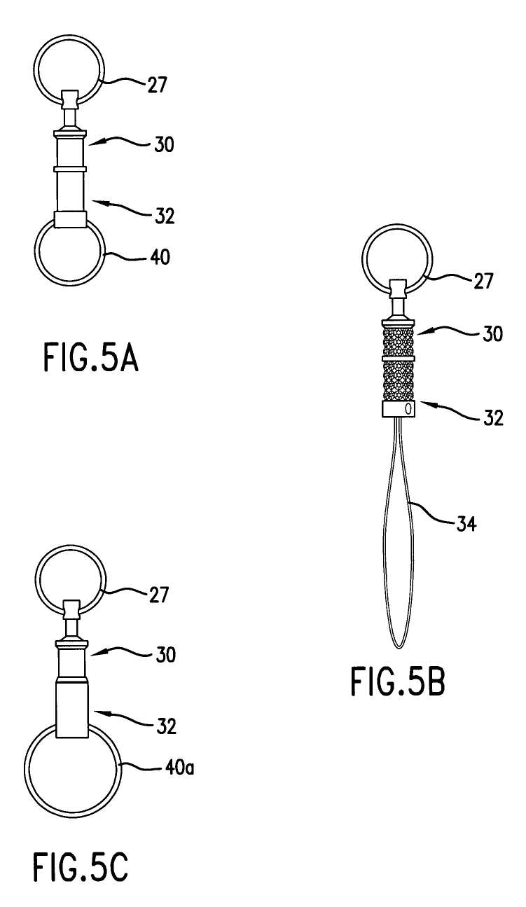

Referring now to FIGS. 5A, 5B and 5C where the coupling 30 is shown in detail, it is seen that there are several arrangements for the coupling. In FIG. 5A, a relatively small split ring 40 having a diameter of 1 inch is used, while in FIG. 5C a larger split ring 40A having a diameter of 1¼ inch is used. This is the primary difference between the coupling 30 of FIG. 5A and the coupling 30′ of FIG. 5C. FIG. 5B has the strand 34 for connecting to the cell phone 12 instead of the second split rings 40 and 40A. In each case, the first split ring 27 is looped through a loop 28 at a second end of the strap 16. The strap 16 is attached to a person or bag using the carabiner 18 with the closure link 19 that pivots opening the carabiner 18 for engagement around structure such as a belt loop 20 or a handle of a purse (not shown).

The rings 27 of FIGS. 5A-5C are received through an aperture 66 in the rod 52 while the rings 40 and 40A are received through an aperture 68 of the sleeve 62. The strand 34 is held in the sleeve 62 by a bead 70, which upon assembly of the quick release key loop 32, is retained within the interior 60 of the sleeve 62 with the strand 34 configured as a loop passing through an aperture 72 in the end of the sleeve 62. The bead 70 in an illustrated example, is a plastic bead with the ends of the strand 34 adhered thereto with high strength glue such as “KRAZY GLUE™”.

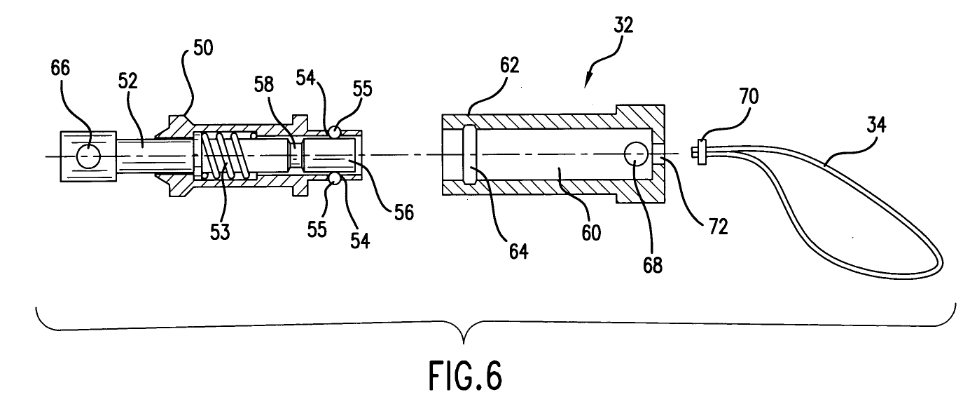

Referring now to FIG. 6, where the quick release key ring 32 is shown, it is seen that the quick release key ring is comprised of an insert 50 having a rod 52 therein where the rod is biased by a spring 53 in a outward direction until the rod 52 hits a stop. The insert 50 also has a pair of recesses 54 in which two ball detents 55 are seated. Normally, the ball detents 55 are held projected by an end portion 56 of the rod 52, however when the rod 52 is pressed inwardly into the insert 50, a relieved portion 58 of the rod 52 allows the ball detents 55 to be cammed inwardly so as to be received in the relieved portion 58. Upon inserting the insert 50 into the interior 60 of a sleeve 62, the ball detents 55 engage in a groove 64 when the rod 52 is allowed to move outwardly under the action of the spring 53. This locks the insert 50 in the sleeve 62 together.

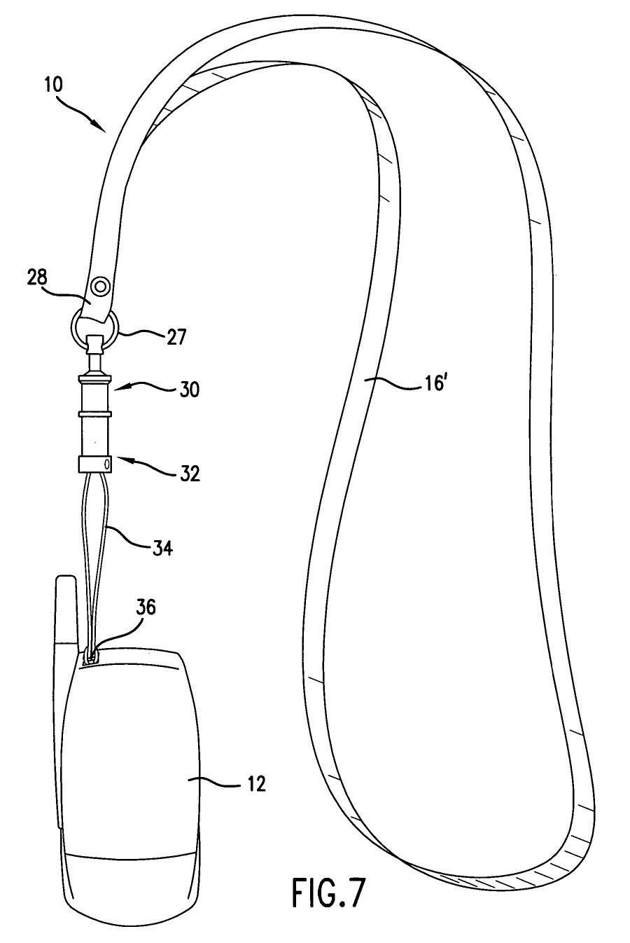

Referring now to FIG. 7 there is shown another embodiment of the invention wherein the strap 16′ is a loop. In this embodiment, the strap 16′ is about 30 inches in length and is looped around a person's neck to suspend the cell phone 12 from the person's neck in the manner of a necklace. The 30 inch strap 16′ is preferably not elastic. While a strand loop 30 is shown in FIG. 7 for attaching to the cell phone 12, either the split ring 40 or the split ring 40A may be utilized.

Since the quick release key loop 32 does not require the insert 50 to move into the sleeve 62 when the elements are assembled, the surface of the insert 50 and the sleeve 54 may be decorative and include, for example, flat back crystals 100 adhered thereto as is shown in FIGS. 3 and 5B.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding U.S. Provisional Application Ser. No. 60/594,549, filed Apr. 18, 2005, is incorporated by reference herein.

From the foregoing description, one skilled in the art can easily ascertain the essential characteristics of this invention and, without departing from the spirit and scope thereof, can make various changes and modifications of the invention to adapt it to various usages and conditions.

We claim:

1. A lanyard for carrying a portable electronic communications device comprising:
a strap of flexible material having first and second end portions, wherein the first end portion attaches the strap flexible material to a person and the second end portion has a coupler for attaching the electronic communications device to the strap;
the coupler comprising a first loop having a substantially rigid configuration, the loop being received in a complementary loop formed in the strap;
a quick release key ring having a first part with a first aperture therearound for receiving the first loop allowing the first part to slide on the first loop and a second part in detachable relation to the first part, the second part having a second aperture therethrough for receiving a second loop, and the second loop of the quick release key ring being connected to the portable electronic communications device.

2. The lanyard of claim 1 wherein the strap is formed as a loop with the first end portion of the strap looping around the neck of the person and the second end portion is also formed as a loop.

3. The lanyard of claim 2 wherein a second end portion of the strap forming a loop is configured by inserting a rivet through opposed portions of the strap.

4. The lanyard of claim 2 wherein the strap is non-elastic.

5. The lanyard of claim 2 wherein the strap forming lanyard has a length of about thirty inches.

6. The lanyard of claim 5 wherein the second loop is a split ring or a strand of flexible material.

7. The lanyard of claim 1 wherein the first loop is a split ring.

8. The lanyard of claim 1 wherein the first end of the strap is a loop and wherein a carabiner is received through the loop for securing first end of the lanyard to the person.

9. The lanyard of claim 8 wherein the strap of material is elastic.

10. The lanyard of claim 8 wherein the first loop is a split ring.

11. The lanyard of claim 10 wherein the second loop is split ring.

12. The lanyard claim 10 wherein the second loop is a strand of flexible material.

13. The lanyard of claim 8 wherein the length of the strap is about six to about twelve inches.

14. The lanyard of claim 2 wherein the lanyard has a length of about fifteen inches with the strap having a length of about thirty inches.
